(19) United States
(12) Patent Application Publication
(10) Pub. No.: US 2016/0241157 A1
(43) Pub. Date: Aug. 18, 2016

(54) SMALL POWER HARVESTING METHODS FOR POWERING CONTROL DEVICES USING A SINGLE POWER LINE

(71) Applicant: GENERAL ELECTRIC COMPANY, Schenectady, NY (US)

(72) Inventor: Yehuda Daniel Levy, Lod (IL)

(21) Appl. No.: 14/845,429

(22) Filed: Sep. 4, 2015

Related U.S. Application Data
(60) Provisional application No. 62/115,250, filed on Feb. 12, 2015.

(51) Int. Cl. H02M 7/06

(52) U.S. Cl. CPC H02M 7/06

(57) ABSTRACT

A power harvesting circuit includes a first switch connected in series between an AC source and a load, a switch control circuit connected to the switch and operable to cause the switch to cycle AC power to the load, and a power collection circuit for collecting power resulting from the power cycling. A method of power harvesting includes cycling AC power to a load using a switch, and collecting power generated by the power cycling and providing the collected power for use by a load control circuit. An active controller includes a load control circuit, and a power harvesting circuit having first switch connected in series between an AC source and a load, a switch control circuit connected to the switch and operable to cause the switch to cycle AC power to the load, and a power collection circuit for collecting power resulting from the power cycling.

The disclosed exemplary embodiments relate generally to electrical equipment, and more particularly to providing power to control devices.

### BACKGROUND

In many existing AC wiring systems, the neutral line may not be accessible because it may be routed separately from the phase line and may be connected directly to the load. In systems using traditional switches or other passive devices, access to the neutral line may not be required. FIG. 1 schematically illustrates such a system where power is provided to a load 105 from an AC line voltage source 100 by a neutral wire 110 that is not accessible, and by a phase wire 115 with a conventional switch 120 in series with the load 105. In this example, at least the neural wire 110 is not accessible. In other examples, the AC line voltage source 100 and the load 105 may also be inaccessible. However, many active controllers, for example, programmable controllers for HVAC and lighting, require connections to both the phase and neutral lines for their own operating power. It may be impossible to Install an active controller requiring both phase and neutral connections into a circuit with an inaccessible neutral line.

It would be desirable to provide an apparatus and method for providing power in the absence of an accessible neutral conductor.

### SUMMARY

As described herein, the exemplary embodiments overcome one or more of the above or other disadvantages known in the art.

The exemplary embodiments are directed to a power harvesting circuit including a first switch connected in series between an AC source and a load, a switch control circuit connected to the switch and operable to cause the switch to cycle AC power to the load, and a power collection circuit for collecting power resulting from cycling the AC power for use by a load control circuit.

The switch control circuit may be operable to cause the first switch to cycle AC power to the load by periodically applying power to the load.

The power collection circuit may include a transformer primary winding in series with the AC source and the load, and a rectifier connected to a secondary winding of the transformer to provide power to the load control circuit.

The switch control circuit may be operable to cause the first switch to cycle AC power to the load by periodically interrupting AC power to the load.

The power collection circuit may be connected in series with the AC source and the load when the first switch interrupts AC power to the load.

The power collection circuit may include a rectifier, an inductor and a capacitor connected in series with the AC source and the load when the first switch interrupts AC power to the load.

A DC voltage may be developed across the capacitor when the first switch interrupts AC power to the load and is used to provide power to the load control circuit.

The power harvesting circuit may include a comparator with inputs connected to the capacitor and a voltage reference and an output connected to a second switch configured to disconnect the rectifier, inductor and capacitor when the DC voltage across the capacitor exceeds a threshold determined from the voltage reference.

The exemplary embodiments are also directed to a method of power harvesting including cycling AC power to a load using a switch, and collecting power generated by cycling the AC power and providing the collected power for use by a load control circuit.

The method may include cycling AC power to the load by periodically applying AC power to the load.

Collecting power generated by cycling the AC power may include rectifying power from a transformer connected in series with the AC source and the load to provide power to the load control circuit.

The method may include cycling AC power to the load by periodically interrupting power to the load.

Collecting power generated by cycling the AC power may be performed when power to the load is interrupted.

Collecting power generated by cycling the AC power may include charging a capacitor through a rectifier and an inductor in series with the AC source and the load when power to the load is interrupted.

Providing the collected power for use by the load control circuit may include providing a DC voltage developed across the capacitor when power is interrupted to the load to the load control circuit.

The method may include comparing the DC voltage developed across the capacitor with a voltage reference and disconnecting the rectifier, inductor and capacitor when the voltage across the capacitor exceeds a threshold determined from the voltage reference.

The exemplary embodiments are also directed to an active controller having a load control circuit, and a power harvesting circuit including first switch connected in series between an AC source and a load, a switch control circuit connected to the switch and operable to cause the switch to cycle AC power to the load, and a power collection circuit for collecting power resulting from cycling the AC power for use by a load control circuit.

The switch control circuit may be operable to cause the first switch to cycle AC power to the load by periodically applying power to the load.

The power collection circuit may include a transformer primary winding in series with the AC source and the load, and a rectifier connected to a secondary winding of the transformer to provide power to the load control circuit.

The switch control circuit may be operable to cause the first switch to cycle AC power to the load by periodically interrupting AC power to the load.

The power collection circuit may be connected in series with the AC source and the load when the first switch interrupts AC power to the load.

The power collection circuit may include a rectifier, an inductor and a capacitor connected in series with the AC source and the load when the first switch interrupts AC power to the load.

A DC voltage may be developed across the capacitor when the first switch interrupts AC power to the load and is used to provide power to the load control circuit.

The active controller may include a comparator with inputs connected to the capacitor and a voltage reference and an output connected to a second switch configured to disconnect the rectifier, inductor and capacitor when the voltage across the capacitor exceeds a threshold determined from the voltage reference.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and unless otherwise indicated, they are merely intended to conceptually illustrate the structures and procedures described herein. In addition, any suitable size, shape or type of elements or materials could be used.

### BRIEF DESCRIPTION OF THE DRAWINGS

In the drawings:

FIG. 1 schematically illustrates an AC system where power is provided to a load;

FIG. 2 shows a block diagram of a power harvesting application according to the disclosed embodiments;

FIG. 3 shows a block diagram of a load control circuit for use with the disclosed embodiments;

FIG. 4 shows a block diagram of an exemplary circuit implementation of the power harvesting application illustrated in FIG. 2;

FIG. 5 shows a block diagram of another exemplary circuit implementation of the power harvesting application illustrated in FIG. 2;

FIG. 6 shows simulation results of the exemplary embodiment of FIG. 5.

FIG. 7 shows a set of simulated results for the embodiment of FIG. 5 where the harvested current causes pulses across a load; and

FIG. 8 shows a simulated result of optionally providing a capacitor in parallel with the load for applications where the load draws a reduced current.

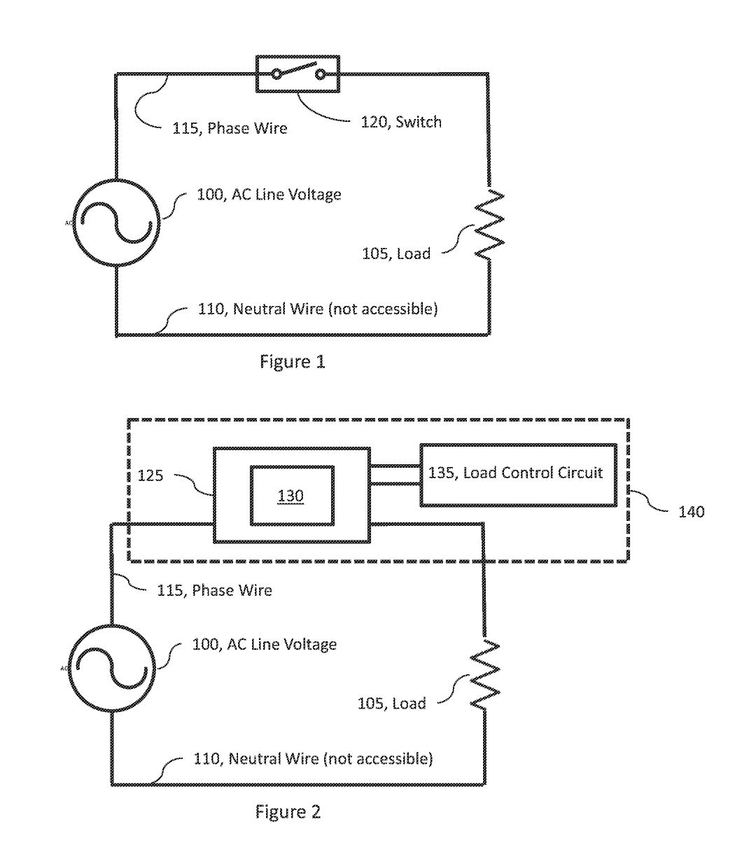

### DETAILED DESCRIPTION

The disclosed embodiments are directed to a method and apparatus for providing power in the absence of an accessible neutral wire or conductor. The exemplary embodiments generally operate to cycle power to a load, and collect power resulting from cycling the power. As used herein, the term “cycling power” may be defined as periodically applying power to the load or periodically interrupting power to the load.

FIG. 2 shows a block diagram of an example of the disclosed embodiments. A power harvesting circuit 125 is connected in series between the AC line voltage source 100 and the load 105. The power harvesting circuit 125 generally includes circuitry 130 for collecting and delivering power to load control circuit 135 which operates to control AC power delivered to the load 105. Load control circuit 135 may include one or more of a programmable multifunction controller, programmable on-off timer, dimming controller, wireless controller, occupancy sensor, light triggered device, or any module or circuitry for controlling power to a load. While the power harvesting circuit 125 and the load control circuit 135 may be separate, it should be understood that the power harvesting circuit 125 and the load control circuit 135 of the disclosed embodiments may be implemented together or integrated together as at least part of an active controller 140.

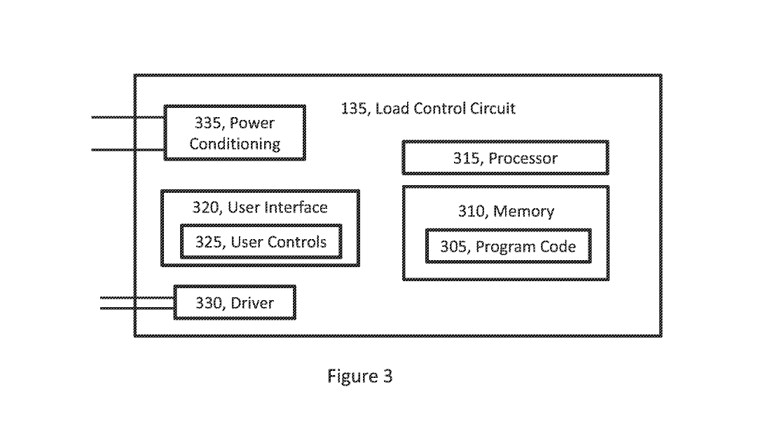

As shown in FIG. 3, the load control circuit 135 generally includes computer readable program code 305 stored on at least one computer readable medium for operating the power harvesting circuit 125 and for controlling AC power delivered to the load 105. The computer readable medium may be a memory 310 of the microcontroller 115. The load control circuit 135 may also include a processor 315 for executing the computer readable program code 305. In at least one aspect, the load control circuit 135 may include one or more input or output devices, including a user interface 320. The user interface 320 may include user controls 325 for programming the load control circuit 135 and for receiving user input and for providing information to the user. In at least one embodiment, the user controls 325 may be used instead of the conventional switch 120. The load control circuit 135 may also include driver circuitry 330 for driving components of the power harvesting circuit 125. The load control circuit 135 may also include power conditioning circuitry 335 for conditioning and optionally storing power provided by the power harvesting circuit 125. The power conditioning circuitry 335 may include a power storage device, for example, one or more of a battery or a capacitor.

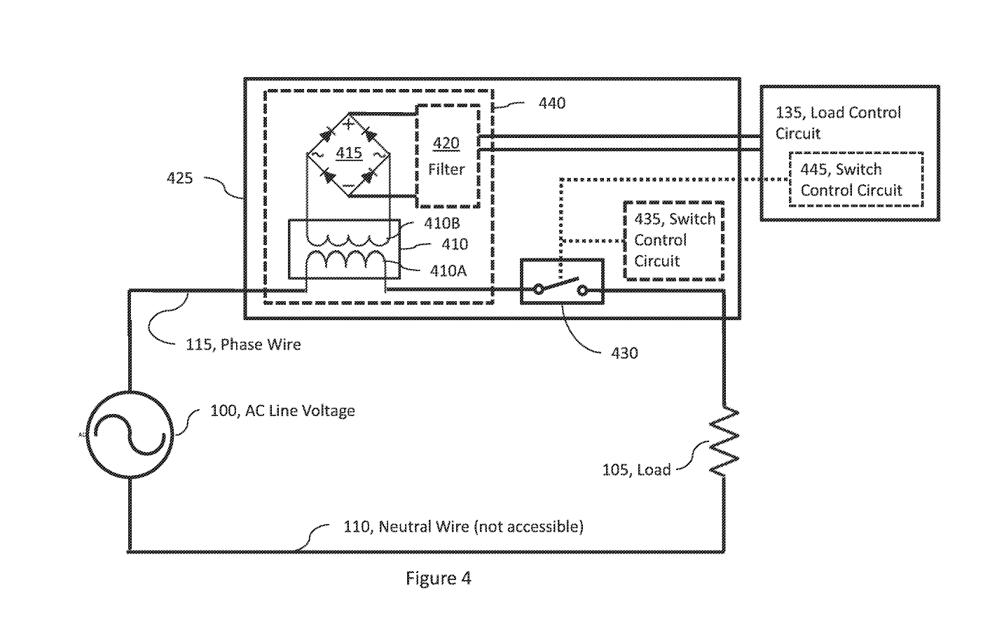

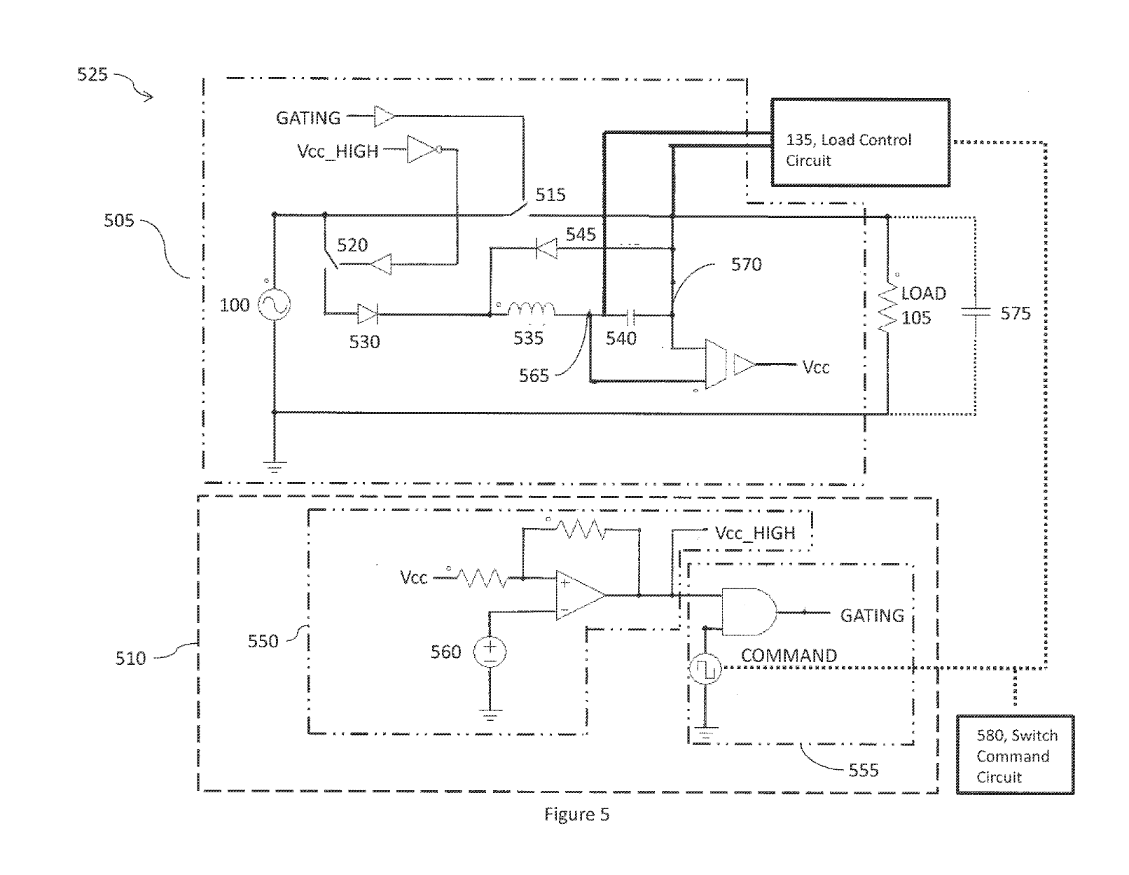

FIG. 4 shows an exemplary embodiment of a power harvesting circuit 425 according to the disclosed embodiments, where power may be harvested or collected when power is provided to the load 105. In this embodiment, the power harvesting circuit 425 may include a power collection circuit 440, a switch 430, and a switch control circuit 435, 445. The power collection circuit 440 may include a transformer 410, a rectifier 415, and an optional filter 420. A primary winding 410A of the transformer 410 may be connected in series between the AC line voltage source 100 and the switch 430, and the switch 430 may be connected in series between the primary winding 410A of the transformer 410 and the load 105. A secondary winding 410B of the transformer 410 may be connected to an AC input of the rectifier 415. The DC output of the rectifier 415 may be connected to the load control circuit 135, optionally though the filter 420. The load control circuit 135 may include a switch control circuit 445 connected to the switch 430 for controlling the operation of the switch 430. Some embodiments may include a switch control circuit 435 separate from the load control circuit 135.

When the switch 430 is closed, current flows through the transformer 410, is rectified by the rectifier 415, may optionally be filtered or otherwise conditioned by filter 420 and provided to the load control circuit 135. The switch 430 may be an electronically controlled switch and may be controlled by the switch control circuit 435, 445. When power is applied to the load, the power harvesting circuit 425 provides power to the load control circuit 135. The power conditioning circuitry 335 of the load control circuit 135 may optionally store the power for use by the load control circuit 135 when the switch 430 is open.

In one or more embodiments, when power is not normally applied to the load 105 and the switch 430 is normally open, the switch control circuit 435, 445 may operate to close the switch 430 periodically to generate power for the load control circuit 135. The switch control circuit 435, 445 may apply a signal with a constant duty cycle and period to the switch 430. In some embodiments the switch control circuit 435, 445 may only apply the signal when the load control circuit 135 determines that power is required. In one or more embodiments, the switch control circuit 435, 445 may also apply a signal to the switch 430 with a variable duty cycle and a variable period. The duty cycle and period of the switch closure may be selected to be less than a reaction time of the load 105. Thus, the switch 430 may be in the on or conducting state for a short period of time such that there is no perceptible activity by the load. For example, where the load 105 is an incandescent lamp, the duty cycle and period of the switch closure may be selected to provide power to the load control circuit 135 without lighting the lamp.

FIG. 5 shows another embodiment of a power harvesting circuit 525, according to the disclosed embodiments, where power is harvested or collected when power is interrupted to the load 105. In this embodiment, the power harvesting circuit 525 may include a power collection circuit 505 and a switch control circuit 510. The power collection circuit 505 may include a switch 515 in series between the AC line voltage source 100 and the load 105. In parallel with the switch 515, another switch 520, a diode 530, an inductor 535 and a capacitor 540 may be connected in series. A free wheeling diode 545 may be connected in parallel with the series connected inductor 535 and capacitor 540 to eliminate any voltage spikes across the inductor 535. The terminals 565, 570 of the capacitor 540 may be connected to the load control circuit 135 to supply power to the load control circuit 135.

The switch control circuit 510 may include a comparator section 550 and a signal generator section 555. The comparator section 550 compares the voltage Vcc across capacitor 540 with a voltage reference 560 and generates a Vcc_HIGH signal for controlling switch 520 when the voltage Vcc across capacitor 540 exceeds a predetermined threshold. The signal generator section 555 combines the Vcc_HIGH signal and a COMMAND signal to provide a GATING signal for controlling switch 515.

The COMMAND signal may be provided by the load control circuit 135 or a separate switch command circuit 580. The load control circuit 135 or the switch command circuit 580 may provide the COMMAND signal with a constant duty cycle and period. In some embodiments the load control circuit 135 or the switch command circuit 580 may only provide the COMMAND signal when the load control circuit 135 determines that power is required. In one or more embodiments, the load control circuit 135 or the switch command circuit 580 may also provide the COMMAND signal with a variable duty cycle and a variable period. The duty cycle and period of the COMMAND signal may be selected such that the resulting GATING signal causes the switch 515 to be open for a time period less than a reaction time of the load 105. Thus, the switch 515 may be in the off or non-conducting state for a short period of time such that there is no perceptible change in activity by the load. For example, where the load 105 is an incandescent lamp, the duty cycle and period of the COMMAND signal may be selected to interrupt power to the lamp without perceptively extinguishing or otherwise changing the output of the lamp.

In operation, switch 520 is normally closed and switch 515 is closed to apply power to the load 105. The GATING signal is provided to open the switch 515 periodically to generate power for the load control circuit 135. When switch 515 opens, power is provided through switch 520, rectified by diode 530, and applied to a first terminal 565 of capacitor 540 through inductor 535. A second terminal 570 of capacitor 540 is grounded through the load 105. The power accumulated across terminals 565, 570 terminals of the capacitor 540 is provided to the load control circuit 135. If the voltage Vcc across capacitor 540 exceeds a predetermined threshold, the comparator section 550 generates the Vcc_HIGH signal causing switch 520 to open, preventing capacitor 540 from charging until the voltage Vcc no longer exceeds the predetermined threshold.

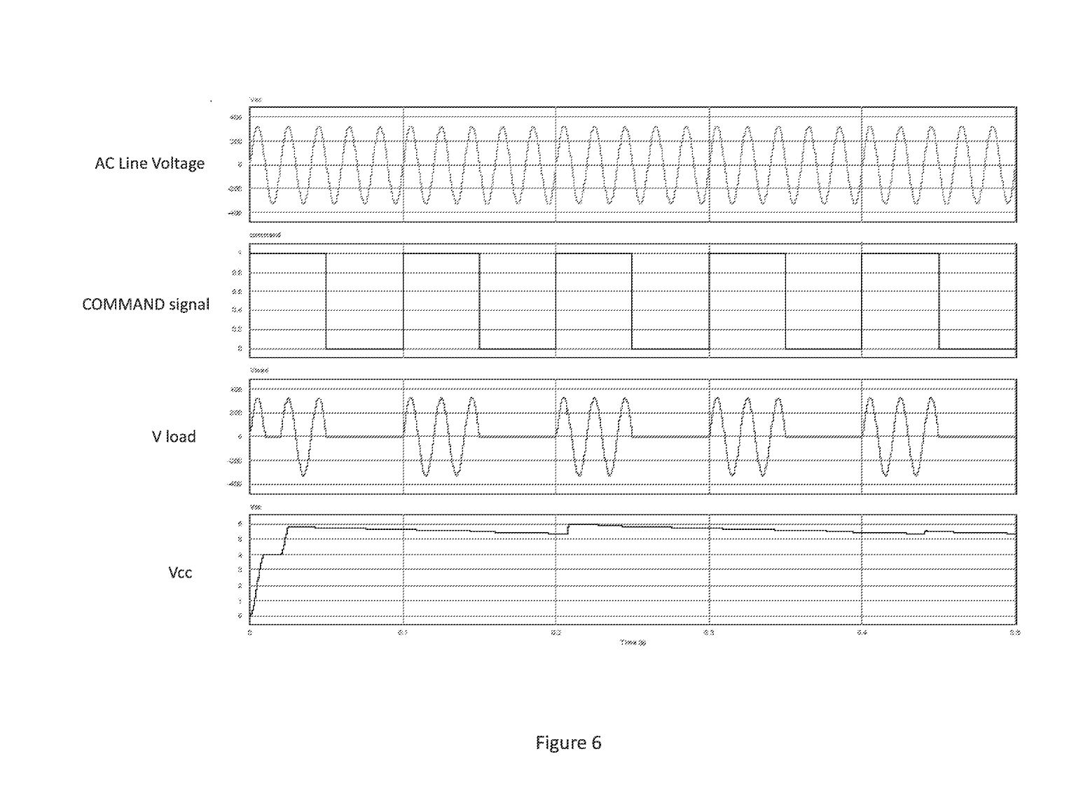

FIG. 6 shows a set of exemplary simulated results for the embodiment of FIG. 5 where the AC line voltage is 240 VAC, the load 105 draws 1A, and the generated COMMAND signal is a 10 Hz square wave. By interrupting the power to the load every 0.05 seconds the power collection circuit 505 produces a Vcc of approximately 5 VDC when the current drawn by the load control circuit 135 is approximately 5 mA.

Generally, the amount of power harvested for use by the load control circuit 135 may be insignificant when compared to the current drawn by the load 105. However, in applications where the effective resistance of the load is higher and the current drawn by the load is smaller, the amount of power available for harvesting may be decreased because the load is in series with the power harvesting circuitry. Furthermore, it may be difficult to select a duty cycle and period for the signals from the load control circuit 135 or the switch control circuit 435, 580 that is less than the reaction time of the load 105.

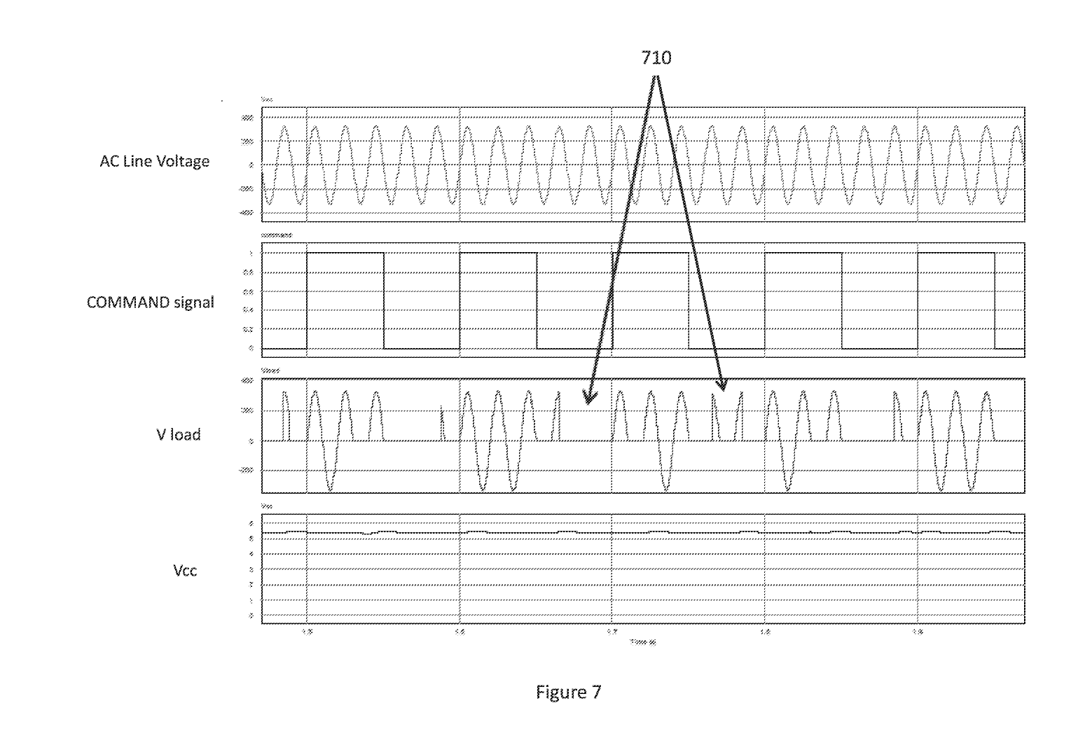

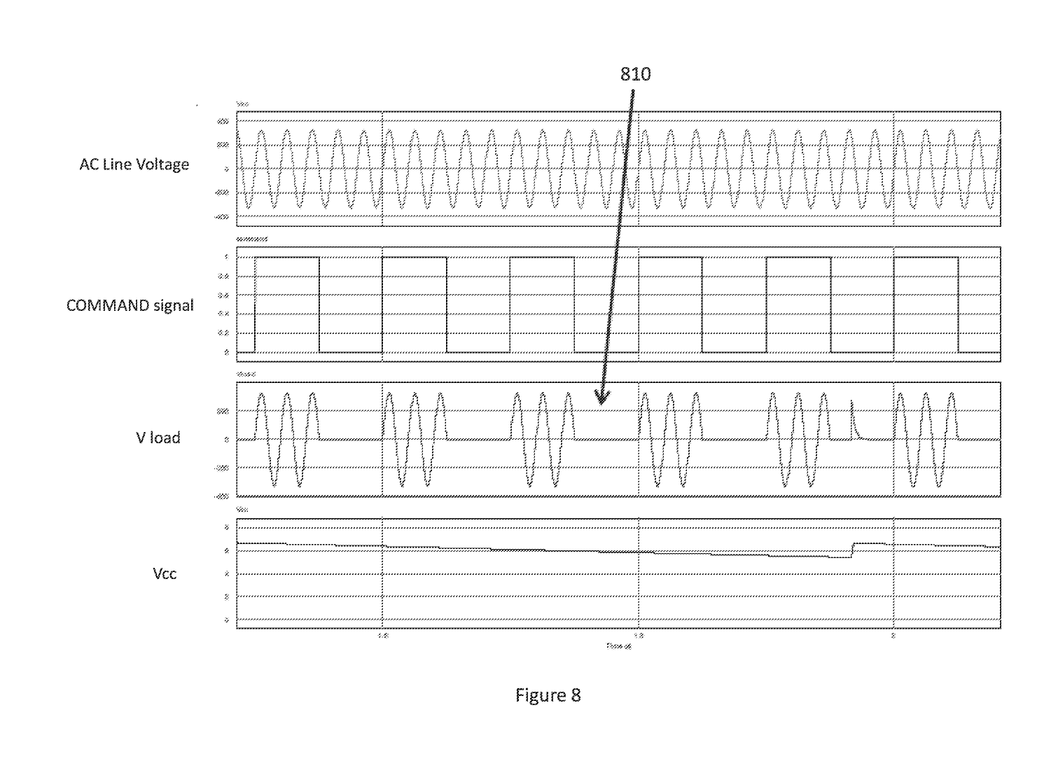

FIG. 7 shows a set of simulated results for the embodiment of FIG. 5 where the current drawn by the load 105 may be approximately 1/20 of the current drawn by the load in the simulation depicted in FIG. 6. Pulses 710 may appear across the load 105 when power has been interrupted and may create disturbances or may cause a reaction by the load, for example, lighting or extinguishing a light when the load is an incandescent lamp. FIG. 8 shows the simulated result 810 of optionally providing a capacitor 575 (FIG. 5) in parallel with the load 105 to compensate for the decreased load current.

The disclosed embodiments provide techniques for providing power for control circuits in the absence of an accessible neutral conductor. The embodiments include circuitry for cycling power to a load and harvesting or collecting power available as a result of cycling the power. The power harvesting circuits disclosed herein may be implemented to provide power to a pre-existing control circuit, or the power harvesting circuits and a control circuit may be implemented together as at least part of an active controller.

Various modifications and adaptations may become apparent to those skilled in the relevant arts in view of the foregoing description, when read in conjunction with the accompanying drawings. However, all such and similar modifications of the teachings of the disclosed embodiments will still fall within the scope of the disclosed embodiments.

Furthermore, some of the features of the exemplary embodiments could be used to advantage without the corresponding use of other features. As such, the foregoing description should be considered as merely illustrative of the principles of the disclosed embodiments and not in limitation thereof.

1. A power harvesting circuit comprising:
a first switch connected in series between an AC source and a load;
a switch control circuit connected to the switch and operable to cause the switch to cycle AC power to the load; and
a power collection circuit for collecting power resulting from cycling the AC power for use by a load control circuit.

2. The power harvesting circuit of claim 1, wherein the switch control circuit is operable to cause the first switch to cycle AC power to the load by periodically applying power to the load.

3. The power harvesting circuit of claim 2, wherein the power collection circuit includes a transformer primary winding in series with the AC source and the load, and a rectifier connected to a secondary winding of the transformer to provide power to the load control circuit.

4. The power harvesting circuit of claim 1, wherein the switch control circuit is operable to cause the first switch to cycle AC power to the load by periodically interrupting AC power to the load.

5. The power harvesting circuit of claim 4, wherein the power collection circuit is connected in series with the AC source and the load when the first switch interrupts AC power to the load.

6. The power harvesting circuit of claim 5, wherein the power collection circuit includes a rectifier, an inductor and a capacitor connected in series with the AC source and the load when the first switch interrupts AC power to the load.

7. The power harvesting circuit of claim 6, wherein a DC voltage is developed across the capacitor when the first switch interrupts AC power to the load and is used to provide power to the load control circuit.

8. The power harvesting circuit of claim 7, comprising a comparator with inputs connected to the capacitor and a voltage reference and an output connected to a second switch configured to disconnect the rectifier, inductor and capacitor when the DC voltage across the capacitor exceeds a threshold determined from the voltage reference.

9. A method of power harvesting comprising:
cycling AC power to a load using a switch; and
collecting power generated by cycling the AC power and providing the collected power for use by a load control circuit.

10. The method of claim 9, comprising cycling AC power to the load by periodically applying AC power to the load.

11. The method of claim 10, wherein collecting power generated by cycling the AC power comprises rectifying power from a transformer connected in series with the AC source and the load to provide power to the load control circuit.

12. The method of claim 9, comprising cycling AC power to the load by periodically interrupting power to the load.

13. The method of claim 12, wherein collecting power generated by cycling the AC power is performed when power to the load is interrupted.

14. The method of claim 13, wherein collecting power generated by cycling the AC power comprises charging a capacitor through a rectifier and an inductor in series with the AC source and the load when power to the load is interrupted.

15. The method of claim 14, wherein providing the collected power for use by the load control circuit comprises providing a DC voltage developed across the capacitor when power is interrupted to the load to the load control circuit.

16. The method of claim 15, comprising comparing the DC voltage developed across the capacitor with a voltage reference and disconnecting the rectifier, inductor and capacitor when the DC voltage across the capacitor exceeds a threshold determined from the voltage reference.

17. An active controller comprising:
a load control circuit; and
a power harvesting circuit including:
first switch connected in series between an AC source and a load;
a switch control circuit connected to the switch and operable to cause the switch to cycle AC power to the load; and
a power collection circuit for collecting power resulting from cycling the AC power for use by a load control circuit.

18. The active controller of claim 17, wherein the switch control circuit is operable to cause the first switch to cycle AC power to the load by periodically applying power to the load.

19. The active controller of claim 18, wherein the power collection circuit includes a transformer primary winding in series with the AC source and the load, and a rectifier connected to a secondary winding of the transformer to provide power to the load control circuit.

20. The active controller of claim 17, wherein the switch control circuit is operable to cause the first switch to cycle AC power to the load by periodically interrupting AC power to the load.

21. The active controller of claim 20, wherein the power collection circuit is connected in series with the AC source and the load when the first switch interrupts AC power to the load.

22. The active controller of claim 21, wherein the power collection circuit includes a rectifier, an inductor and a capacitor connected in series with the AC source and the load when the first switch interrupts AC power to the load.

23. The active controller of claim 22, wherein a DC voltage is developed across the capacitor when the first switch interrupts AC power to the load and is used to provide power to the load control circuit.

24. The active controller of claim 23, comprising a comparator with inputs connected to the capacitor and a voltage reference and an output connected to a second switch configured to disconnect the rectifier, inductor and capacitor when the DC voltage across the capacitor exceeds a threshold determined from the voltage reference.
